(19) United States
(12) Patent Application Publication
(10) Pub. No.: US 2025/0045535 A1
(43) Pub. Date: Feb. 6, 2025

(54) USING A LARGE LANGUAGE MODEL TO IMPROVE TRAINING DATA

(71) Applicant: Roku, Inc., San Jose, CA (US)

(72) Inventors: Kapil Kumar, London (GB); Abhishek Majumdar, Santa Clara, CA (US); Nitish Aggarwal, Sunnyvale, CA (US); Srimaruti Manoj Nimmagadda, Saratoga, CA (US)

(73) Assignee: Roku, Inc., San Jose, CA (US)

(21) Appl. No.: 18/423,789

(22) Filed: Jan. 26, 2024

Related U.S. Application Data
(60) Provisional application No. 63/516,720, filed on Jul. 31, 2023.

(51) Int. Cl. G06F 40/40

(52) U.S. Cl. CPC G06F 40/40

(57) ABSTRACT

Training data can significantly impact the performance of machine learning models. Its impact may be more significant in transfer learning. Different data sources can be used to generate training data used in transfer learning. The training data originating from user interaction logs may be subject to presentation bias. The training data originating from model generated labeled data may have false positives. Poor quality training data may cause the machine learning model to perform poorly. To address some of these concerns, a checker having one or more models can check for false positives and for labeled data entries that may have been subject to presentation bias. Such entries may be removed or modified. In some cases, the checker can generate a test that can be used to test the machine learning model and penalize the machine learning model if the model generates an incorrect prediction.

### CROSS-REFERENCE TO RELATED APPLICATIONS

This non-provisional application claims priority to and/or receives benefit from provisional application, titled “USING A LARGE LANGUAGE MODEL TO IMPROVE TRAINING DATA”, Ser. No. 63/516,720, filed on Jul. 31, 2023. The provisional application is hereby incorporated by reference in its entirety.

### TECHNICAL FIELD

This disclosure relates generally to large language models, and more specifically, using a large language model to improve training data and to teach a machine learning model.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

Figure (FIG. 1 illustrates transfer learning, according to some embodiments of the disclosure.

FIG. 2 illustrates exemplary data sources used in generating training data and a checker to check for false positives and/or presentation bias, according to some embodiments of the disclosure.

FIG. 3 illustrates a checker to generate a test to test a machine learning model and updating the machine learning model based on the result of the test, according to some embodiments of the disclosure.

FIG. 4 illustrates exemplary implementations of a checker having a model, according to some embodiments of the disclosure.

FIG. 5 illustrates exemplary implementations of a checker having an ensemble of models, according to some embodiments of the disclosure.

FIG. 6 is a flowchart showing a method for removing labeled data entries, according to some embodiments of the disclosure.

FIG. 7 is a flowchart showing a method for modifying labeled data entries, according to some embodiments of the disclosure.

FIG. 8 is a flowchart showing a method for using a machine learning model to teach a further machine learning model, according to some embodiments of the disclosure.

FIG. 9 is a block diagram of an exemplary computing device, according to some embodiments of the disclosure.

### DETAILED DESCRIPTION

### Overview

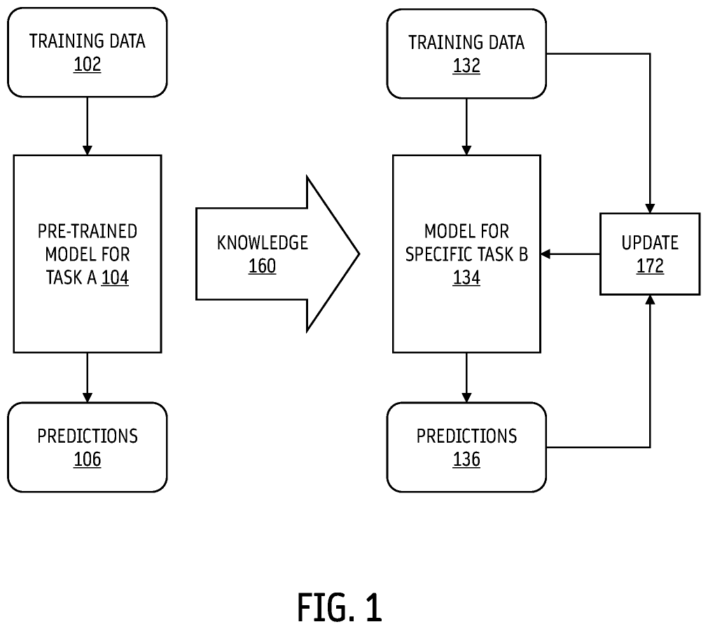

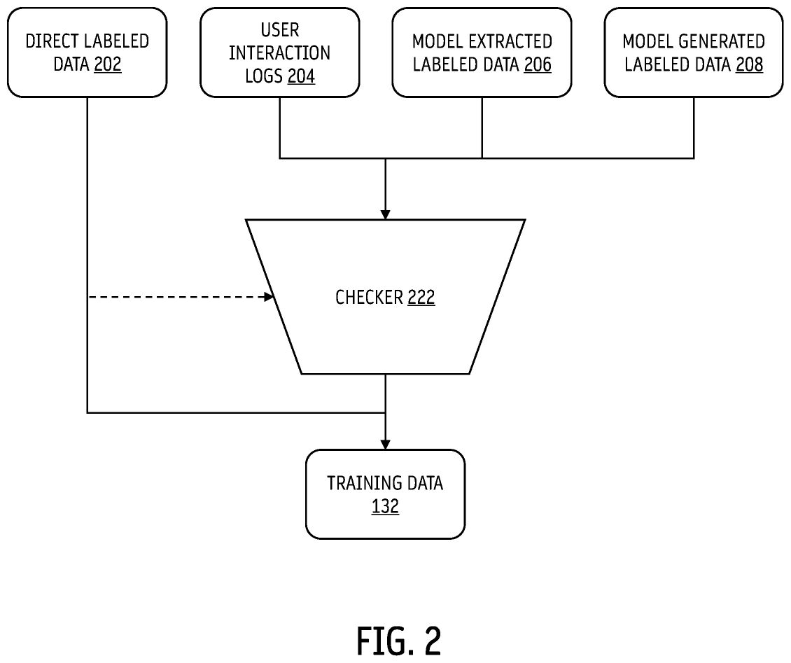

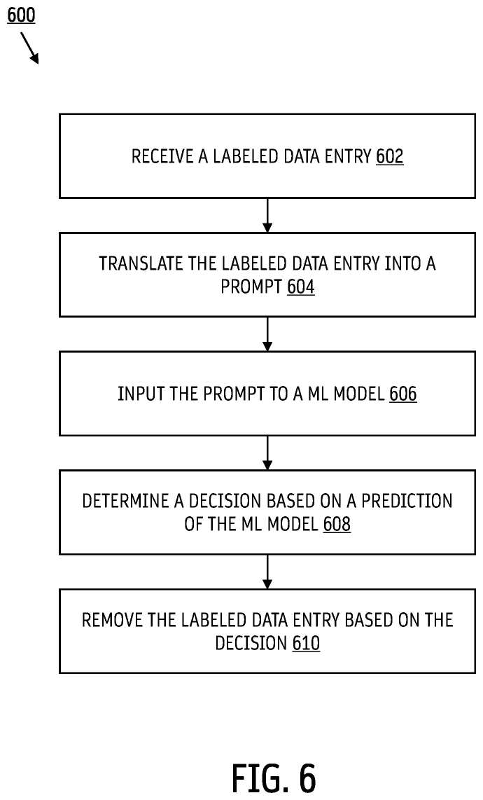

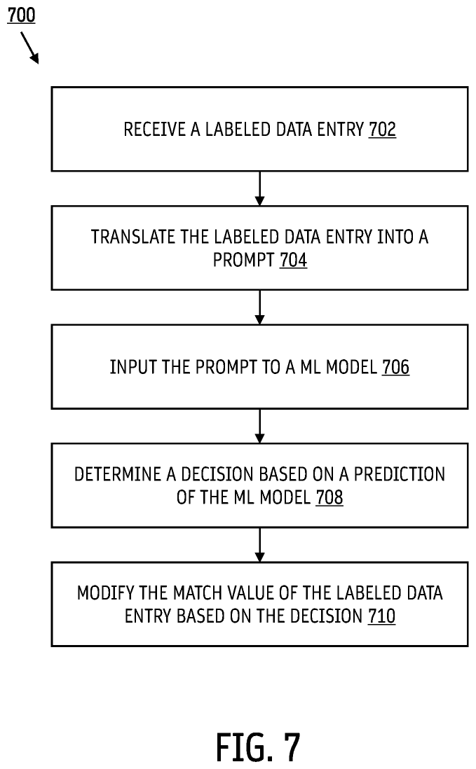

Training data can significantly impact the performance of machine learning models. Its impact may be more significant in transfer learning. Different data sources can be used to generate training data used in transfer learning. The training data originating from user interaction logs may be subject to presentation bias. For example, user interaction logs may not accurately represent true opinions of the user. User interaction logs may be influenced by the way the information is presented to the users. The training data originating from model generated labeled data may have false positives. For example, labeled data that has incorrect labels are considered false positives. Poor quality training data may cause the machine learning model to perform poorly. To address some of these concerns, a checker having one or more models can check for false positives and for labeled data entries that may have been subject to presentation bias. Such entries may be removed or modified. Exemplary processes implemented by the checker are illustrated in FIGS. 2-5. Exemplary detailed methods are illustrated in FIGS. 6-7.

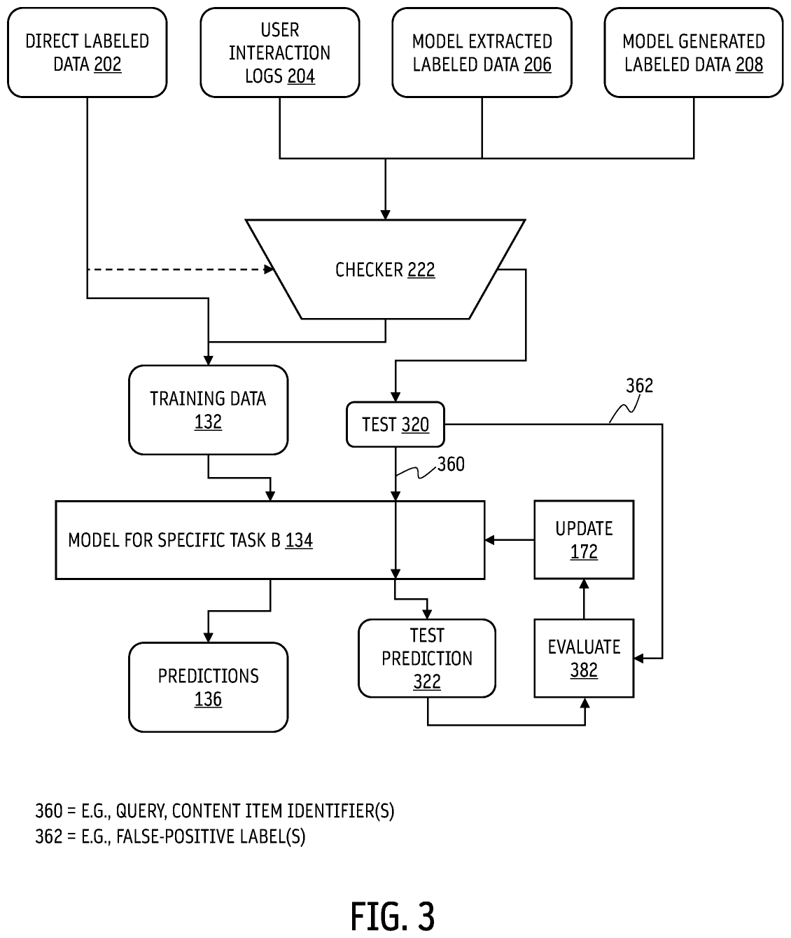

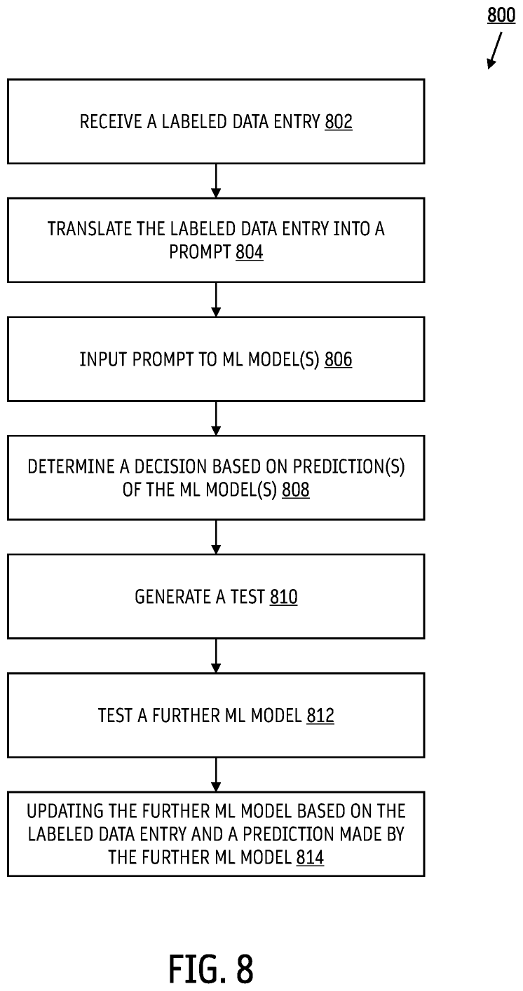

In some cases, the checker can generate a test that can be used to test the machine learning model and penalize the machine learning model if the model generates an incorrect prediction. Exemplary model testing processes and model training processes are illustrated in FIGS. 1 and 3. Exemplary detailed methods are illustrated in FIG. 8.

Challenges with Semantic Search

Content providers may manage and allow users to access and view thousands to millions or more content items. Content items may include media content, such as audio content, video content, image content, augmented reality content, virtual reality content, mixed reality content, game, textual content, interactive content, etc. Finding exactly what a user is looking for, or finding what the user may find most relevant can greatly improve the user experience. In some cases, a user may provide voice-based or text-based queries to find content items. Examples of queries may include:
“Show me funny office comedies with romance”
“TV series with strong female characters”
“I want to watch 1980s romantic movies with a happy ending”
“Short animated film that talks about family values”
“Are there blockbuster movies from 1990s that involves a tragedy?”
“What is that movie where there is a Samoan warrior and a girl going on a sea adventure?
“What are some most critically-acclaimed dramas right now?” and
“I want to see a film set in Tuscany but is not dubbed in English.”

Machine learning models can be effective in interpreting a query and finding content items that may match with the query. Machine learning models may implement natural language processing to interpret the query. Machine learning models may include one or more neural networks (e.g., transformer-based neural networks). Machine learning models may include a large language model (LLM). User experience with retrieval of content items in response to a query can depend on whether the machine learning models can retrieve content items that the user is looking for in the query.

### Transfer Learning

FIG. 1 illustrates transfer learning, according to some embodiments of the disclosure. Transfer learning is a technique in machine learning that involves using the knowledge learned from one task to improve the performance on a related but different task. For example, a model that can recognize cars can use its learned features to recognize trucks more easily. Transfer learning is useful when there is not enough training data for the new task, and when the new task is similar to the previous one. Transfer learning can be used to develop a potentially more lightweight model with a reasonable amount of training data based on a heavyweight model that is already pre-trained.

Pre-trained (or off-the-shelf) model for task A 104 may include a machine learning model, such as an LLM. Task A may include a generalized task, or a specific task. Pre-trained model for task A 104 may have been trained with large amounts of training data 102 to generate large number of predictions 106. Pre-trained model for task A 104 may have tens of millions to billions of weights. Training data 102 may include general text data from the Internet and/or other data sources. Pre-trained model for task A 104 is unlikely to be suitable for a specific task with certain business goals and requirements. Pre-trained model for task A 104 may perform well when solving generic semantic relationship or question-answering type problems. Pre-trained model for task A 104 may perform poorly in a specific domain, e.g., retrieval or recommendation of content items that are semantically relevant to the query, while being relevant for the business and/or while meeting domain-specific requirements.

It is possible to adapt pre-trained model for task A 104 using transfer learning to develop a model for specific task B 134. Specific task B may involve semantic search for content items, e.g., retrieval or recommendation of content items that are semantically relevant to the query. Model for specific task B 134 may be used in a content item retrieval system/engine or a content item recommendation system/engine. Through transfer learning, pre-trained model for task A 104 may be used as a starting point for developing model for specific task B 134. Knowledge 160 from pre-trained model for task A 104 can be transferred to model for specific task B 134. Model for specific task B 134 may be trained to perform specific task B (different from task A). Training data 132 can be provided to model for specific task B 134, and model for specific task B 134 can make predictions 136 from the training data 132. Training data 132 and predictions 136 can be used to train model for specific task B 134. Update 172 can examine an error in the predictions 136 made based on training data 132 and compute a loss function. An error may be based on whether a given prediction corresponds to ground truth presented in the training data 132. Using the loss function, update 172 can update weights used in model for specific task B 134 accordingly so that model for specific task B 134 continues to improve. Update 172 may update the weights used in the model for specific task B 134 to minimize the loss function.

Machine learning models, such as model for specific task B 134, can be trained using loss functions through an optimization process. Optimization is the task of finding the best set of parameters (e.g., weights) for a machine learning model that minimizes the loss function. The loss function can measure how well the model fits the data and how close its predictions are to the true values. The lower the loss function value, the better the model performance. Examples of methods of optimization may include: gradient descent, stochastic gradient descent, and Adam. These methods use different strategies to update the parameters (e.g., weights) of the model based on the gradient of the loss function. The gradient is a vector that points in the direction of the steepest increase of the loss function. By moving in the opposite direction of the gradient, the parameters (e.g., weights) can be adjusted to reduce the loss function value. The optimization process can be iterative and requires multiple passes over the data to converge to a good solution. The number of iterations and the learning rate (how much the parameters change in each step) are hyperparameters that can affect the speed and quality of the optimization.

Transfer learning may involve adding artificial neural network layers to existing artificial neural network layers of pre-trained model for task A 104 and updating the weights in the added artificial neural network layers in training while not updating the weights of the existing artificial neural network layers. Transfer learning may involve using the pre-trained model for task A 104 as a feature extraction model and adding one or more artificial neural network layers to further process the features extracted by the pre-trained model for task A to build model for specific task B 134. Training data 132 and predictions 136 can be used by update 172 to train the added artificial neural network layers. Transfer learning may involve update 172 fine-tuning the weights of one or more existing artificial neural network layers transferred from pre-trained model for task A 104.

The performance of model for specific task B 134, how well model for specific task B 134 performs task B, can depend on training data 132. If poor quality training data 132 goes in, the parameters (e.g., weights) of the model for specific task B 134 would try to fit to poor quality training data 132. As a result, the model for specific task B 134 would make poor quality predictions and perform poorly. Conversely, if good quality training data 132 goes in, the parameters (e.g., weights) of the model for specific task B 134 would try to fit to good quality training data 132. As a result, the model for specific task B 134 would make better quality predictions and perform better.

Training data 132 may be poor for one or more reasons. Training data 132 may be biased. Training data 132 may not be aligned with business goals or domain requirements. Training data 132 may be noisy. Training data 132 may be agnostic to other affinities or considerations unrelated to semantic affinity (e.g., affinities relating to business goals or domain requirements). Aspects of training data 132 can impact model for specific task B 134's performance, generalization, fairness, and adaptation to perform specific task B.

In some cases, model for specific task B 134 may be trained using training data 132 which includes labeled data entries in the following format:

{query}{content_item(s)}→{match_value(s)}

A labeled data entry may include a query. A labeled data entry may include one or more content items. A labeled data entry may include one or more match values corresponding to one or more content items.

Query portion in a labeled data entry may include a string. Query may include semantic information. Query may include one or more tokens. Query may include one or more words. Query may have semantic meaning. Query may include a question. Query may include a sentence or statement.

Content_item portion in a labeled data entry may include one or more content item identifiers corresponding to one or more content items. A content item identifier may include a (unique) text descriptor describing a content item. A content item identifier may include a hash value generated from the content item. A content item identifier may include a (unique) numerical value. A content item identifier may include a (unique) resource locator to the content item, or information about the content item. A content item identifier may include a (unique) path to the content item, or information about the content item. A content item identifier may include content item metadata, or other suitable information about the content item.

Match_value portion in a labeled data entry may include one or more labels (or one or more ground truth labels) corresponding to one or more content items identified in content_item respectively. A content item identified in content_item may have one or more corresponding labels or ground truth labels. A label may indicate an affinity or a match of a given content item to the query, e.g., along a particular dimension. In some cases, a content item identified in content_item may have an affinity value vector or a match value vector having one or more match/affinity values along different dimensions measuring or quantifying affinity/match of the given content item to the query. Exemplary affinity/match dimensions may include dimensions or features of a content item, such as, title, genre, description, plot, metadata, sentiment, popularity, etc. An exemplary affinity/match value vector may include a plurality of affinity/match values for a content item identified in content_item of a labeled data entry to the query, e.g., [title to query affinity, genre to query affinity, sentiment to query affinity, metadata to query affinity]. Some exemplary affinity/match dimensions may include dimensions or features of the query, such as, keywords or salient words/tokens in the query, etc. An exemplary affinity/match value vector may include a plurality of affinity/match values for a content item identified in content_item of a labeled data entry to the query, e.g., [query keyword1 affinity, query keyword2 affinity, query keyword3 affinity]. A match/affinity value may be binary (e.g., 0 and 1). A match/affinity value may be selected from +1 and −1. A match/affinity value may be selected from +1, 0, and −1. A match/affinity value may include a value within a range between 0 and 1. A match/affinity value may include a value within a range between +1 and −1.

### Example Labeled Data Entries May Include:

Query=“Depressing documentary about the ocean”, Content_item-“438673315”, and match_value=“1”
   “438673315” may be a content item identifier, and may correspond to a content item titled, “The Extinction of White Whales in the Atlantic Ocean” in Alaska “,
Query=” Mockumentary-style TV series set Content item=“147468754”, and match value=“1”
   “147468754” may be a content item identifier, and may correspond to a content item titled, “Denali Park Rangers Gone Wild”.
Query=“Standup comedy special about food and cats”, Content item=“687684164”, and match_value=[“0”, “0.5”, “0.7”, “0.2”]
   “687684164” may be a content item identifier, and may correspond to a content item titled, “White House correspondents' dinner 2019 speech compilation”
Query=“Standup comedy special about food and cats”, Content_item=[“546867435”, “33433122”], and match_value=[“0.8”, “0.9”]
   “546867435” may be a content item identifier, and may correspond to a content item titled, “Don't call me a crazy cat lady”
   “33433122” may be a content item identifier, and may correspond to a content item titled, “I'm not alone. I have five cats.”
Query=“Standup comedy special about food and cats”, Content_item=[“546867435”, “33433122”], and match_value=[[“0.3”, “0.5”, “0.4”], [“0.1”, “0.8”, “0.9”]]
   “546867435” may be a content item identifier, and may correspond to a content item titled, “Don't call me a crazy cat lady”
   “33433122” may be a content item identifier, and may correspond to a content item titled, “I'm not alone. I have five cats.”

In some cases, model for specific task B 134 may be used in a search engine or recommendation engine to retrieve, based on a query, semantically relevant content items and/or content items that may be most salient, interesting, or pertinent to the query. In some embodiments, model for specific task B 134 may include a classifier, such as a binary classifier, that determines whether a query matches a content item or not. A classifier may determine a score and applies a cut-off or threshold to the score to determine whether a content item matches the query or not. Model for specific task B 134 may include a machine learning model, such as a large language model, that can output a probability score or other suitable score that quantifies or predicts whether a content item matches a query. A large language model may be trained to give a score or a confidence score that a content item belongs to the query.

In some embodiments, update 172 may compute errors and the loss function based on how close a prediction is from the ground truth label (e.g., whether the prediction is a positive). In some embodiments, model for specific task B 134 may include a model which is trained using a triplet loss function. Update 172 may compute errors and the loss function based on how close a prediction is to a positive ground truth label and how far away the prediction is from a negative ground truth label. Update 172 may minimize the distance to the positive ground truth label and maximize the distance from the negative ground truth label when updating weights of model for specific task B 134.

### Exemplary Data Sources Used for Generating Training Data and Checking for False Positives

FIG. 2 illustrates exemplary data sources used in generating training data and a checker 222 to check for false positives and/or presentation bias, according to some embodiments of the disclosure. Training data 132 may be generated from one or more data sources, such as direct labeled data 202, user interaction logs 204, model extracted labeled data 206, and model generated labeled data 208.

Direct labeled data 202 may include labeled data extracted from data sources such as the Internet, curated content on the Internet, peer-reviewed content on the Internet, editor/domain expert tagged or labeled content, and content item metadata databases. Data sources may include direct mapping of query to content items, which can be easily translated into labeled data entries for use as part of training data 132. Direct labeled data 202 may be agnostic to considerations such as popularity, streaming hours, and/or click-through rate. For a query involving drama, a majority of content items may be tagged or labeled with drama as the genre, and most of these items may be unpopular (e.g., rarely clicked or launched by users). Training on direct labeled data 202 may bias the model to retrieve mainly long-tailed items (e.g., content items that are unpopular, or rarely clicked or launched by users). Direct labeled data 202 can be limited to a fixed set of categories (e.g., queries, tags, or labels) used in the data sources. Some categories may have sparse coverage. Relatively few content items may be associated with categories such as fly fishing, hockey, etc. Sparse categories may limit the model's capability to predict for these categories. Direct labeled data 202 may not capture semantic dimension(s) of a query to a content item. For a query involving “Sherlock Holmes”, direct labeled data 202 may have labeled data entries that associate the query to content items where the content items feature Sherlock Holmes as the character, and not data entries that associate the query to content items where the plots are around detective stories, or British themed stories, or historical events. Direct labeled data 202 may cause the model to overfit to the labeled data entries and cause the model to not pay attention to semantic dimensions of the query.

User interaction logs 204 may include instances or events encoding or capturing how users may have interacted with a content item. An exemplary instance or event is where a user is browsing through a category of content items, and the user subsequently clicks on a content item. An exemplary instance or event is where a user is browsing through a category of content items retrieved based on a query, and a content item appeared to the user (e.g., an impression, appeared in the semantic search results). Another exemplary instance or event is where a user is browsing through a category of content items, and the user subsequently launches a content item. Another exemplary instance or event is where a user is browsing through a category of content items, and the user did not engage with a content item. Another exemplary instance or event is where a user is browsing through a set of content items retrieved based on a user-provided query and interacted with a content item. Another exemplary instance or event is where a user is browsing through a set of content items retrieved based on a user-provided query, and the user subsequently consumed or engaged with a content item from the set for a certain duration. User interaction logs 204 may capture popularity of a content item. User interaction logs 204 may capture user preferences or user habits. User interaction logs 204 may capture variations of queries used by users. User interaction logs 204 can depend on what the users are doing on the user interface. Sometimes, users may randomly engage with or interact with a content item that is irrelevant or unrelated to the query (or category). User interaction logs 204 may involve noisy data entries or false positives. In some cases, user interaction logs 204 may be biased. User interaction logs 204 may be subject to presentation bias because the users are interacting with a user interface, and user behavior may be biased or impacted by the user interface. For example, even though an American action movie is unrelated to a query involving a Spanish comedy movie, user interaction logs 204 may reveal many instances where a user clicks on the enticing graphic of a poster of the American action movie. The instances or events each connecting a query and an interaction with a content item can be translated or reformatted into labeled data entries for use as part of training data 132.

Model extracted labeled data 206 may include labeled data that is generated using a machine learning model, e.g., an LLM, and a generative pre-trained transformer model, etc. A prompt including information about a content item may be provided to the machine learning model, prompting the machine learning model to output a query (e.g., a string, labels, genres, categories, tags, keywords, a summary, etc.) that corresponds to the content item based prompt. For example, a prompt may include a content item's metadata, such as plot line, synopsis, director, list of actors, list of artists, list of athletes/teams, list of writers, list of characters, length of content item, language of content item, country of origin of content item, genre, category, tags, presence of advertising content, viewers' ratings, critic's ratings, parental ratings, production company, release date, release year, platform on which the content item is released, whether it is part of a franchise or series, type of content item, sports scores, viewership, popularity score, minority group diversity rating, audio channel information, availability of subtitles, beats per minute, list of filming locations, list of awards, list of award nominations, seasonality information, etc. A prompt may include a webpage written about the content item. The webpage may be peer-edited or peer-reviewed. The webpage may be fact-checked. The prompt may request the machine learning model to determine, generate, and output possible queries (e.g., strings, genres, categories, tags, keywords, a summary, etc.) that would correspond to the content item. In some cases, the machine learning model may be prompted with information about the content item and asked to generate a summary about the content item. One or more queries (e.g., strings, genres, categories, tags, keywords, a summary, etc.) can be extracted from the summary and used to generate labeled data entries. In some cases, the machine learning model may be prompted with information about the content item and asked to generate one or more queries to which the content item may strongly match. One or more queries (e.g., strings, genres, categories, tags, keywords, a summary, etc.) can be used to generate labeled data entries. The extracted queries and the content item can be translated or reformatted into labeled data entries for use as part of training data 132. Model extracted labeled data 206 may capture semantic dimensions of a query when detailed prompts are used but can be subject to a risk of hallucinations by the machine learning model (e.g., the machine learning model generating queries that are made-up and do not correspond to the content item).

Model generated labeled data 208 may include labeled data that is generated using one or more (machine learning) model that finds the additional semantically relevant content items that correspond to a given query. Model generated labeled data 208 may generate additional labeled data entries based on existing labeled data entries. In some embodiments, the model may build and/or include a semantic graph, knowledge graph, and/or social graph that encode relationships between a library of content items. Once a graph that connects different content items is built, the model may use the graph to generate labeled data. For example, the model may use a given (existing) labeled data entry (e.g., from direct labeled data 202), and determine additional labels by applying techniques such as semantic graph search. Semantic graph search may determine that additional content items are related to a given content item, and therefore, the additional content items may also match the query. The (machine learning) model can implement a search for additional semantically relevant matches to a query on a graph (e.g., through random walk through a semantic graph, knowledge graph, and/or social graph) to find additional content items that are semantically relevant to a query based on the graph. In some embodiments, the machine learning model can extract feature embeddings of content items and find nearest neighbors to a content item that matches a given query, which may have the most similar latent representations or features to the content item. The nearest neighbors can include additional semantically relevant content items to the given query. In some embodiments, a model (e.g., a large language model) be prompted to determine whether one or more additional content items may also be related to a query in the similar way that a given content item is related to a query in a labeled data entry. The additional semantically relevant content items and the query can be translated or reformatted into labeled data entries for use as part of training data 132.

Direct labeled data 202 may have human errors in the labeled data entries. User interaction logs 204 may have labeled data entries that are subject to presentation bias. Presentation bias in user interaction logs 204 can refer to a phenomenon where search engines or recommendation systems display certain content items more prominently based on, e.g., past user interactions, external factors, etc., even if the content items are not directly relevant to the user's current query. This bias can be driven by user engagement metrics, such as clicks, likes, or dwell time (e.g., the time spent on a particular page). This bias can be driven by how the content item is presented to the user. As users interact with the presented content times, the user interactions are included as user interaction logs 204 (and subsequently into training data 132) as positive signals to a machine learning model, such as model for specific task B 134 of FIG. 1. The positive signals with presentation bias may influence or impact future searches and rankings performed by the machine learning model. Model extracted labeled data 206 and model generated labeled data 208 may involve processes that do not involve a human in the loop and may be uncontrolled. One or more sources, such as direct labeled data 202, user interaction logs 204, model extracted labeled data 206, and model generated labeled data 208 may include one or more false positives.

As used herein, false positives may include labeled data entries that include human errors. False positives may include labeled data entries that are incorrect due to presentation bias. False positives may include labeled data entries where labels were incorrectly extracted or generated. False positives may include labeled data entries where labels were incorrectly generated due to models retrieving content items which are not semantically relevant to a given query. A machine learning model, such as model for specific task B 134, trained on false positives can suffer from overfitting to the false positives and thereby causing the machine learning model to perform poorly (more likely to make incorrect predictions).

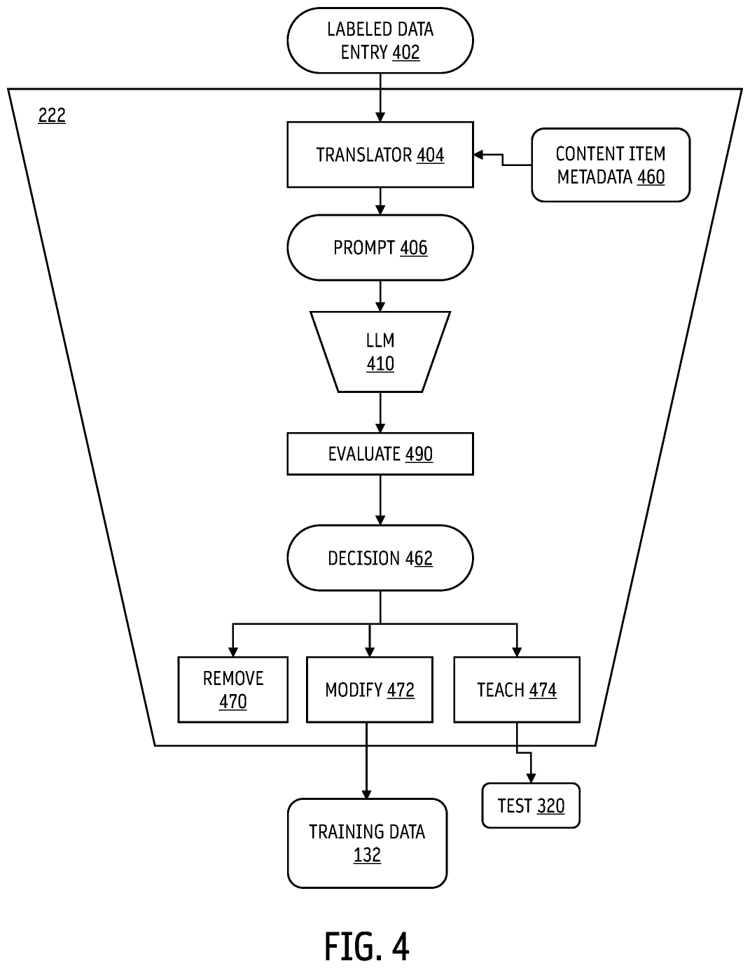

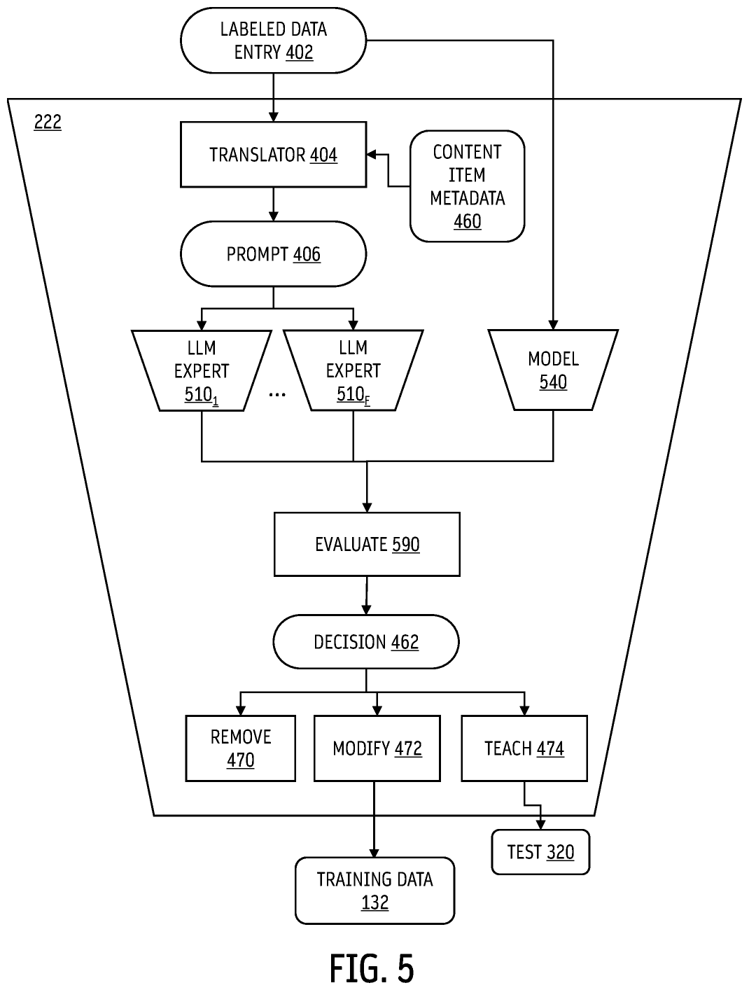

It may be desirable to include checker 222 to determine whether a labeled data entry is a false-positive or not. Checker 222 may determine whether one or more other machine learning models would produce a contrastive prediction that is different from the label in the labeled data entry. Checker 222 can receive labeled data entries generated from one or more data sources, such as direct labeled data 202, user interaction logs 204, model extracted labeled data 206, and model generated labeled data 208. In some embodiments, checker 222 can filter out or modify a labeled data entry before providing it to training data 132. FIGS. 4-5 illustrates exemplary implementations of checker 222.

In some cases, in addition to or in place of filtering out or modifying the labeled data entry, checker 222 can be used to teach a machine learning model. FIG. 3 illustrates a checker 222 to generate a test 320 to test a machine learning model (e.g., model for specific task B 134) and updating the machine learning model based on the result of the test, according to some embodiments of the disclosure. The technical effect of using tests, such as test 320, is to teach the machine learning model to make better predictions, or to not make incorrect predictions. In some cases, test 320 may be used as a negative example or training data for the machine learning model.

Suppose a labeled data entry includes a query, a content item identifier, and a match value, e.g., query=“2000's drama TV series”, content_item=“438673315”, and match_value=“1”. Content item “438673315” may correspond to a documentary titled, “The Extinction of White Whales in the Atlantic Ocean”. The labeled data entry may be a false-positive since the documentary is not a drama TV series released in 2000's. Checker 222, implementing one or more models, can determine that the labeled data entry is a false-positive, or that the labeled data entry has one or more false-positive labels. Checker 222 can generate and output a test 320 if it is determined or decided (or in response to determining or deciding) that a labeled data entry is a false-positive. Checker 222 and similar systems that may be able to make this determination are illustrated in FIGS. 3-4.

Test 320, e.g., generated by checker 222, can include the labeled data entry, e.g., where the labeled data entry was considered or determined to be a false-positive. Test 320 may include a least a portion of the labeled data entry. The labeled data entry may include a query, one or more content items identifiers, and one or more match values. The one or more match values may include one or more false-positive labels (determined or identified by checker 222). The query and the one or more content item identifiers in test 320 can be used to test or assess model for specific task B 134 to determine whether the model for specific task B 134 would make an incorrect prediction or produce one or more incorrect outputs. The query and the one or more content item identifiers in test 320 can be used as an input 360 to test or assess model for specific task B 134 to determine whether the model for specific task B 134 would produce the same or similar false-positive label(s) of the labeled data entry in test 320. In response to receiving input 360 generated from test 320, model for specific task B 134 may generate one or more test predictions 322.

Evaluate 382 may receive one or more test predictions 322 and one or more false-positive labels 362 of test 320. Evaluate 382 may examine or compare one or more test predictions 322 and one or more false-positive labels 362 in the labeled data entry considered to be a false-positive in test 320 to determine whether the test prediction 322 is an incorrect prediction, or whether the test prediction 322 matches the false-positive label 362 in the labeled data entry considered to be a false-positive.

Test 320 may include information a labeled data entry (identified as a false-positive by checker 222). Labeled data entry may include:
Query=“Depressing documentary about the ocean”
Content_item=“438673315”
   “438673315” may be a content item identifier, and may correspond to a content item titled, “Ingenious Kitchen Inventions During the Depression Era”
match_value=“1”
   the match_value may be a false-positive label because the content item does not appear to be semantically relevant to the query

Query and content_item of the labeled data entry in test 320 can be provided as input 360 to model for specific task B 134. Query and content_item may be translated into a prompt suitable for model for specific task B 134, and the prompt may be used as input 360. In some cases, the prompt may be the same or similar to a prompt that was used in checker 222 to check whether the labeled data entry was a false-positive or not.

Model for specific task B 134 may produce test prediction 322 based on test 320.

The test prediction 322 may include a prediction that indicates content_item=“438673315” as a (positive) match to the query in test 320. Test prediction 322 may include positive label, or a match/affinity value=“0.9”.

Evaluate 382 may compare the test prediction 322 (e.g., match_value=“0.9”), and the false-positive label 362 in test 320 (e.g., match value=“1”). Such test prediction 322 may match the false-positive label 362 in the labeled data entry in test 320 considered to be a false-positive, because the values are close to each other. Evaluate 382 may determine that test prediction 322 (e.g., match_value=“0.9”), and the false-positive label 362 in test 320 (e.g., match value=“1”) are sufficiently similar to each other. Evaluate 382 may determine that test prediction 322 (e.g., match_value=“0.9”), and the false-positive label 362 in test 320 (e.g., match value=“1”) are consistent with each other. Evaluate 382 may consider the test prediction 322 to be incorrect, or to be a false-positive. Evaluate 382 may determine that test prediction 322 matches test 320, e.g., the false-positive label 362 in test 320.

In some cases, evaluate 382 may output a (binary) classification whether the test prediction 322 matches the test 320. In some cases, evaluate 382 may output a score or value indicating a degree at which the test prediction 322 matches the test 320. The score or value may indicate how poorly model for specific task B 134 performed in response to test 320. The score or value may indicate how confused model for specific task B 134 was in response to test 320.

In response to determining the test prediction 322 is an incorrect prediction (e.g., the test prediction 322 matches the labeled data entry considered to be a false-positive), update 172 would count the test prediction 322 as an error, and compute a loss function according to the error. Update 172 may scale the error in a manner to (heavily) penalize model for specific task B 134 for making an incorrect prediction. Update 172 can update weights of model for specific task B 134 based on the loss function (e.g., as if the model for specific task B 134 made an incorrect prediction). Update 172 may use the labeled data entry in test 320 as a negative training sample or negative sample. Update 172 may use the labeled data entry in test 320 as a negative ground truth label in a triplet loss function, and update weights of model for specific task B 134 to maximize the distance of predictions from the negative ground truth label.

Identification of false positives by checker 222 in training data can be used as part of a process to collect negative training samples that can be used in teaching a machine learning model, e.g., model for specific task B 134. Phrased differently, the machine learning model can learn from the false positives identified by checker 222 and learn to not to make incorrect predictions.

In some cases, the false positives identified by checker 222 are collected as negative training samples. In some cases, false positives identified by checker 222 and where the model for specific task B 134 produces a test prediction 322 that matches the false-positive are collected as negative training samples.

Using the labeled data entry as a negative training sample can improve model for specific task B 134. Model for specific task B 134 may involve contrastive learning, which may be used in content item retrieval or recommendation engines. Model for specific task B 134 may classify whether a content item is a match or not to a query. Model for specific task B 134 may output a score that measures how closely the content item is a match to a query. Negative training samples can be used to teach model for specific task B 134 to distinguish between positive samples and negative samples.

In some embodiments, update 172 may implement negative sampling. Update 172 may collect negative training samples. Update 172 may randomly select a subset of negative samples from a large pool of negative samples and use the subset to calculate the loss function for each positive sample. The loss function may be defined in a way to maximize the mutual information between the positive pair and minimize it between the negative pairs.

In some embodiments, update 172 may implement hard negative mining. Update 172 may collect negative training samples. Update 172 may select the most difficult or informative negative samples for each positive sample, based on some criteria, e.g., distance, similarity, or loss. Update 172 may focus on the negative samples that are most likely to confuse the model or cause errors and use those negative samples to update the model parameters (e.g., weights).

In some embodiments, update 172 may implement adaptive negative sampling. Update 172 may collect negative training samples. Update 172 may dynamically adjust the number or quality of negative samples for each positive sample, based on some feedback from the model or the environment. Adapting the number or quality of negative samples can help update 172 find the optimal trade-off between exploration and exploitation and avoid overfitting or underfitting.

Exemplary implementations of checker 222, e.g., illustrating how to find false positives, are shown and illustrated in FIGS. 4-5.

### Exemplary Implementations of a Checker that Checks for False Positives

FIG. 4 illustrates exemplary implementations of checker 222 having a model, according to some embodiments of the disclosure. As shown, checker 222 may include a LLM 410, such as a question and answer LLM. Checker 222 may receive and process a labeled data entry 402.

Labeled data entry 402 may include a query (e.g., a string). Labeled data entry 402 may include a content item identifier (e.g., a unique identifier that identifies the content item, a hash value, a title of the content item, etc.). Labeled data entry 402 may include a label that corresponds to the query and the content item. The label may include a match value (e.g., quantifying how well the content item matches the query). In some cases, the match value may be an indication or association that the content item matches the query.

The label may include a high or positive match value. The label may be a positive label. Labeled data entry 402 may be a positive training sample where it is desirable for checker 222 to determine whether the labeled data entry 402 is a true positive or a false-positive.

In some embodiments, checker 222 may be used to determine whether LLM 410 would produce a prediction (e.g., a response and/or determination) that contrasts with the label in labeled data entry 402. A contrasting prediction (e.g., a negative response) to positive label in the labeled data entry 402 may indicate that the labeled data entry 402 is a false-positive. A contrasting prediction (e.g., a positive response) to negative label in the labeled data entry 402 may indicate that the labeled data entry 402 is a false negative.

Checker 222 may include a translator 404. Translator 404 may translate information in the labeled data entry 402 into a prompt 406. Translator 404 may receive or retrieve content item metadata 460 that corresponds to the content item.

Prompt 406 is a string or sentence that can be used as input to LLM 410. Prompt 406 preferably asks the (question and answer) LLM 410 whether a content item, given the content item metadata associated with the content item, is associated with a given query. The (question and answer) LLM 410 may be able to identify matches that are falsely retrieved, e.g., by generating a negative response and responding in the negative to the prompt 406.

Prompt 406 may include a question and context information for the LLM 410 to use when answering the question. Question may include a request whether the content item is relevant to the query, in view of the context information. Context information may include information about a content item, such as content item metadata 460.

Prompt 406 may include a question prompt. Prompt 406 may include a yes or no question (e.g., a question that seeks a yes or no response to the question). Prompt 406 may include a request for a match value indicating whether a content item matches the query. Prompt 406 may include a request for a score or a probability. Prompt 406 may include a request for a confidence score. Prompt 406 may include a request to rank a plurality of content items based on its relevance to a query. Prompt 406 may include a request to select and return a number of top matches to a query in a list of content items. Prompt 406 may include a request to rank a plurality of queries based on its relevance to a content item. Prompt 406 may include a request to select and return a number of top matches to a content item in a list of queries.

Prompt 406 may be in the form of:
“Question: Answer in yes or no. Is {title of content item} a {query}? Context: {content item metadata}”

An example of a labeled data entry 402 may include:
Query=“show me Latin cooking show that involves travel”
Content_item (content item identifier or cid)=“3687452148”. “3687452148” may correspond to a content item with the title “Cooking with Aliens”
Match_value=“1”. Label may correspond to a match value of 1, indicating that the content item is a strong match to the query (likely a false-positive since the content item does not appear semantically relevant to the query)

An example of a prompt 406 may include:

Question: Answer in yes or no. Is Cooking with Aliens a Latin cooking show that involves
travel? Context: “Cooking with Aliens” is an extreme cooking competition show that takes
place in the far reaches of the galaxy. The premise of the show is that a group of chefs
competing for their survival are abducted by aliens and taken to a distant planet where
they must cook for the alien overlords. The chefs would have to use their culinary skills to
create dishes that appeal to the alien palate. The catch is that the aliens have very different
tastes than humans, so the chefs would have to get creative with their ingredients and
cooking techniques. Some of the aliens are friendly and willing to help the chefs gather
ingredients and prepare their dishes, while others are hostile and will do anything to
sabotage them. The chefs must use their wits and their cooking skills to win over the aliens
and avoid being eliminated and ejected into space. The challenges get tougher as the
competition progresses, culminating in a final showdown on a planet that is home to the
most dangerous creatures in the galaxy. If at least one chef survives, the aliens will reverse
global warming on Earth with their ultra advanced technology. The first and only season
of the show was first released in February 2106 for 7 episodes. Repeats are shown on the
Space Network.

LLM 410 may generate a response to prompt 406. Response may be provided to evaluate 490 to determine whether the response was negative or sufficiently negative, which may indicate that the labeled data entry 402 is likely a false-positive. Evaluate 490 may output a decision 462 about the labeled data entry 402, indicating whether the labeled data entry 402 is likely a false-positive or not. Evaluate 490 may determine whether the response contrast with or is different from the label in labeled data entry 402.

In the example of a yes or no question prompt as prompt 406 and the label was a positive label associating the content item to the query, a negative response from LLM 410 may cause evaluate 490 to make decision 462 (e.g., determination) that the query does not match the content item, and therefore the labeled data entry 402 is likely a false-positive. A positive response from LLM 410 may cause evaluate 490 to make decision 462 (e.g., determination) that the query matches the content item, and therefore the labeled data entry 402 is not likely to be a false-positive (but a true positive).

Decision 462 may be binary, e.g., indicating whether labeled data entry 402 is a false-positive or is not a false-positive. Decision 462 may be within a range between 0 and 1 representing a probability or likelihood that labeled data entry 402 is a false-positive or is not a false-positive. Decision 462 may include a confidence score, e.g., indicating a confidence level of decision 462.

One or more actions may occur in response to decision 462 (e.g., determining that the labeled data entry 402 is a false-positive).

In some embodiments, the labeled data entry 402 can be removed by remove 470. Remove 470 may filter out labeled data entry 402, so that the labeled data entry 402 is not added or used in training data 132.

In some embodiments, the labeled data entry 402 is modified by modify 472. Modify 472 may correct the label in labeled data entry 402 based on the response to prompt 406 or the decision 462. For example, the label may be changed to a different value (e.g., 0.5, 0, or −1) to indicate that the query does not match the content item, so that the label more accurately reflects ground truth.

In some embodiments, the labeled data entry 402 is used by teach 474 to generate a test 320. Test 320 can be used to teach a machine learning model using exemplary techniques described with FIG. 3.

FIG. 5 illustrates exemplary implementations of checker 222 having an ensemble of models, according to some embodiments of the disclosure. In some cases, F number of LLM expert models, such as LLM expert 510₁, . . . and LLM expert 510_{F} can be used in checker 222 as an ensemble of LLM experts to output responses or determinations to prompt 406. The LLM expert models may generate different responses about labeled data entry 402 (e.g., responses which may indicate whether labeled data entry 402 is a false-positive or not). F may be an even number. F may be an odd number. Different expert LLM models may process prompt 406 differently and generate different or diverse responses to prompt 406. Different LLM expert models may be trained on different training data sets. Different LLM expert models have different machine learning architectures.

In some cases, a model 540 (one or more models) may be used in checker 222 to fact-check the labeled data entry 402 and generate a response or determination about labeled data entry 402 (e.g., whether labeled data entry 402 is a false-positive or not). Model 540 may implement a fact checking model, which may search a data source for a certain number of reputable references that can confirm the content item matches the query.

A total number of models generating responses or determinations may be an odd number. Responses and/or determinations generated by the plurality of models may be provided to combine 450.

Evaluate 590 may receive the responses and/or determinations from upstream models in checker 222. Evaluate 590 may implement a suitable combination technique to combine the responses and/or determinations in order to produce decision 462 (e.g., finally determining whether the labeled data entry 402 is a false-positive or not). Evaluate 590 may produce decision 462 based on one or more ones of the responses or determinations. Evaluate 590 may determine a combined response/determination and determine whether the combined response/determination is consistent with the (false-positive) label in labeled data entry 402.

Evaluate 590 may implement one or more mechanisms to combine responses and/or determinations into a combined response/determination. The combined response/determination may then be used by evaluate 590 to produce decision 462. Evaluate 490 may evaluate whether the combined response/determination is consistent with the label in labeled data entry 402. Evaluate 490 may evaluate whether the combined response/determination matches with the label in labeled data entry 402.

Evaluate 590 may implement a voting scheme. Responses and/or determinations with a majority of votes (or another suitable majority determination threshold) may become the combined response/determination. For example, if a certain number of responses and/or determinations are negative (and the label was positive), decision 462 may indicate that labeled data entry 402 is a false-positive.

Evaluate 590 may output a mean value of responses and/or determinations as combined response/determination. Evaluate 590 may output a median value of responses and/or determinations as combined response/determination. Evaluate 590 may output a mode value of responses and/or determinations as combined response/determination.

Evaluate 590 may sum or add the responses and/or determinations (or weighted responses and/or determinations where weights for different models may be different), and the sum may become the combined response/determination. Evaluate 590 may check whether the sum crosses a decision confidence threshold. In response to the sum crossing the decision confidence threshold, evaluate 590 may output a predetermined value for decision 462.

In some embodiments, the weights for different models used in evaluate 590 in making decision 462 may be determined using the query that is in the labeled data entry 402. Some models may produce more accurate responses and/or determinations than other models for a given query and may be assigned higher weights. In some embodiments, certain models may be assigned a weight of “1” while some models may be assigned a weight of “0”. In some embodiments, the weights for different models may be produced by a model that takes the query as input and produces a vector of weights that correspond to the different models. In some embodiments, the weights may be used to pre-select the models to use in generating responses and/or determinations in the ensemble of models.

In some embodiments, evaluate 590 may implement bagging, which may involve training different models using different subsets of data, and averaging the responses and or determinations produced by the models to generate the combined response/determination and subsequently decision 462.

In some embodiments, evaluate 590 may implement boosting (e.g., AdaBoost), which may involve training models on a weighted data set, where the weights are updated based on errors of the models. The weights can be used by evaluate 590 to combine the responses and/or determinations produced by the models to generate the combined response/determination and subsequently decision 462.

In some embodiments, evaluate 590 may implement Bayesian averaging, where the responses and/or determinations produced by the models are combined by evaluate 590 based on posterior probabilities of the different models.

Evaluate 590 may implement a logic tree or decision tree that takes the responses and/or determinations s as input and outputs a predetermined value for decision 462 based on the logic tree or decision tree.

Using more than one model in checker 222 may make the decision 462 more robust.

### Exemplary Computer-Implemented Methods

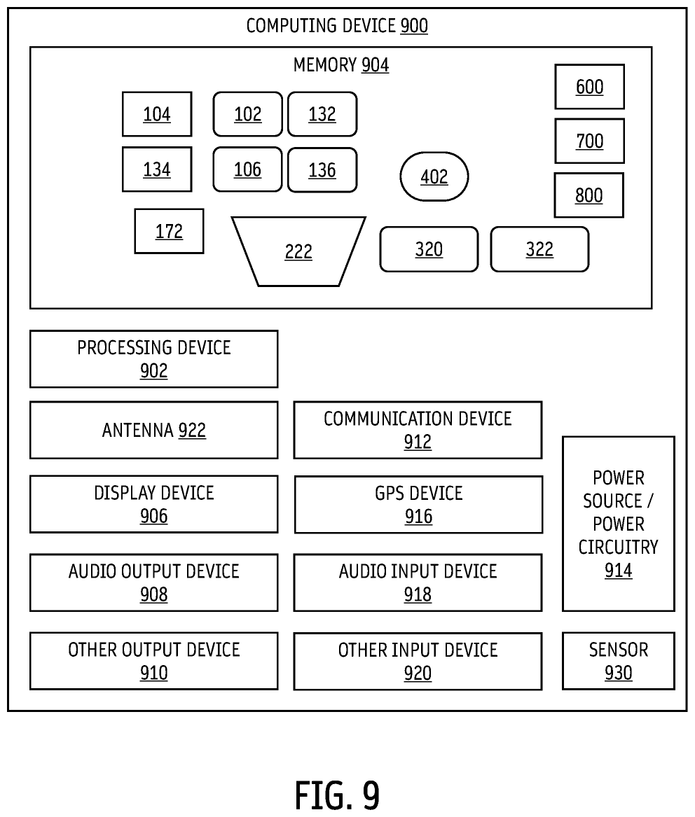

FIG. 6 is a flowchart showing a method for removing labeled data entries, according to some embodiments of the disclosure. Method 600 is illustrated. Method 600 may be implemented by checker 222 as illustrated in the FIGS. Method 600 may be implemented by the computing device 900 of FIG. 9.

In 602, a labeled data entry may be received. The labeled data entry may include a query, an identifier for a content item, and a match value.

In 604, the labeled data entry may be translated (e.g., by a translator) into a prompt. The prompt may include a title of the content item, the query, and metadata associated with the content item.

In 606, the prompt may be input into a machine learning model (e.g., an LLM).

In 608, a decision about the labeled data entry may be determined based on a prediction of the machine learning model in response to the prompt.

In 610, the labeled data entry may be removed from the training data based on the decision.

FIG. 7 is a flowchart showing a method for modifying labeled data entries, according to some embodiments of the disclosure. Method 700 is illustrated. Method 700 may be implemented by checker 222 as illustrated in the FIGS. Method 700 may be implemented by the computing device 900 of FIG. 9.

In 702, a labeled data entry may be received. The labeled data entry may include a query, an identifier for a content item, and a match value.

In 704, the labeled data entry may be translated (e.g., by a translator) into a prompt. The prompt may include a title of the content item, the query, and metadata associated with the content item.

In 706, the prompt may be input into a machine learning model (e.g., an LLM).

In 708, a decision about the labeled data entry may be determined based on a prediction of the machine learning model in response to the prompt.

In 710, the match value of the labeled data entry may be modified based on the decision.

FIG. 8 is a flowchart showing a method for using a machine learning model to teach a further machine learning model, according to some embodiments of the disclosure. Method 800 is illustrated. Method 800 may be implemented by one or more of: checker 222, evaluate 382, update 172, and model for specific task B 134 as illustrated in the FIGS. Method 800 may be implemented by the computing device 900 of FIG. 9.

In 802, a labeled data entry may be received. The labeled data entry may include a query, an identifier for a content item, and a label. Examples of the labeled data entry are described with labeled data entry 402 of FIGS. 4-5. The labeled data entry may be received by checker 222 of the FIGS.

In 804, the labeled data entry may be translated (e.g., by translator 404 of FIGS. 4-5) into a prompt. The prompt may include a title of the content item, the query, and metadata associated with the content item. The prompt may include a request for a match value indicating whether the content item matches the query. The prompt may include context information about the content item. Examples of the prompt are described with prompt 406 of FIGS. 4-5.

In 806, the prompt may be input into one or more machine learning models (e.g., an LLM as illustrated in FIG. 4, an ensemble of models as illustrated in FIG. 5, etc.).

In 808, a decision about the labeled data entry may be determined based on one or more predictions of the machine learning model in response to the prompt. Examples of the decision are described with decision 462 of FIGS. 4-5. The decision may be determined by evaluate 490 of FIG. 4. The decision may be determined by evaluate 590 of FIG. 5. Predictions may include responses and/or determinations made by models and/or machine learning models.

In 810, a test can be generated based on the decision. The test may include the labeled data entry. Examples of the test are described with test 320 of FIGS. 3-6.

In 812, the further machine learning model may be tested using the test. An example of the further machine learning model is model for specific task B 134 of the FIGS. Testing the further machine learning model may include inputting a test prompt (e.g., input 360) into the further machine learning model and observing the output or prediction produced by the further machine learning model. The output or prediction may be evaluated to determine if the further machine learning model predicted correctly or not.

In 814, the further machine learning model may be updated based on the labeled data entry, and a prediction made by the further machine learning model in response to the test. The updating may be performed by evaluate 382 and update 172 as described with FIG. 3.

### Exemplary Computing Device

FIG. 9 is a block diagram of an exemplary computing device 900, according to some embodiments of the disclosure. One or more computing devices 900 may be used to implement the functionalities described with the FIGS. and herein. A number of components are illustrated in the FIGS. as included in the computing device 900, but any one or more of these components may be omitted or duplicated, as suitable for the application. In some embodiments, some or all of the components included in the computing device 900 may be attached to one or more motherboards. In some embodiments, some or all of these components are fabricated onto a single system on a chip (SoC) die. Additionally, in various embodiments, the computing device 900 may not include one or more of the components illustrated in FIG. 9, and the computing device 900 may include interface circuitry for coupling to the one or more components. For example, the computing device 900 may not include a display device 906, and may include display device interface circuitry (e.g., a connector and driver circuitry) to which a display device 906 may be coupled. In another set of examples, the computing device 900 may not include an audio input device 918 or an audio output device 908 and may include audio input or output device interface circuitry (e.g., connectors and supporting circuitry) to which an audio input device 918 or audio output device 908 may be coupled.

The computing device 900 may include a processing device 902 (e.g., one or more processing devices, one or more of the same type of processing device, one or more of different types of processing device). The processing device 902 may include electronic circuitry that process electronic data from data storage elements (e.g., registers, memory, resistors, capacitors, quantum bit cells) to transform that electronic data into other electronic data that may be stored in registers and/or memory. Examples of processing device 902 may include a central processing unit (CPU), a graphical processing unit (GPU), a quantum processor, a machine learning processor, an artificial intelligence processor, a neural network processor, an artificial intelligence accelerator, an application specific integrated circuit (ASIC), an analog signal processor, an analog computer, a microprocessor, a digital signal processor, a field programmable gate array (FPGA), a tensor processing unit (TPU), a data processing unit (DPU), etc.

The computing device 900 may include a memory 904, which may itself include one or more memory devices such as volatile memory (e.g., DRAM), nonvolatile memory (e.g., read-only memory (ROM)), high bandwidth memory (HBM), flash memory, solid state memory, and/or a hard drive. Memory 904 includes one or more non-transitory computer-readable storage media. In some embodiments, memory 904 may include memory that shares a die with the processing device 902. In some embodiments, memory 904 includes one or more non-transitory computer-readable media storing instructions executable to perform operations described with FIGS. 1-8. In some embodiments, memory 904 includes one or more non-transitory computer-readable media storing instructions executable to perform operations of methods illustrated in FIGS. 6-8. Exemplary parts that may be encoded as instructions and stored in memory 904 are depicted. Memory 904 may store instructions that encode one or more exemplary parts. The instructions stored in the one or more non-transitory computer-readable media may be executed by processing device 902. In some embodiments, memory 904 may store data, e.g., data structures, binary data, bits, metadata, files, blobs, etc., as described with the FIGS. and herein. Exemplary data that may be stored in memory 904 are depicted. Memory 904 may store one or more data as depicted.

In some embodiments, the computing device 900 may include a communication device 912 (e.g., one or more communication devices). For example, the communication device 912 may be configured for managing wired and/or wireless communications for the transfer of data to and from the computing device 900. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 912 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 912 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 912 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 912 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 912 may operate in accordance with other wireless protocols in other embodiments. The computing device 900 may include an antenna 922 to facilitate wireless communications and/or to receive other wireless communications (such as radio frequency transmissions). The computing device 900 may include receiver circuits and/or transmitter circuits. In some embodiments, the communication device 912 may manage wired communications, such as electrical, optical, or any other suitable communication protocols (e.g., the Ethernet). As noted above, the communication device 912 may include multiple communication chips. For instance, a first communication device 912 may be dedicated to shorter-range wireless communications such as Wi-Fi or Bluetooth, and a second communication device 912 may be dedicated to longer-range wireless communications such as global positioning system (GPS), EDGE, GPRS, CDMA, WiMAX, LTE, EV-DO, or others. In some embodiments, a first communication device 912 may be dedicated to wireless communications, and a second communication device 912 may be dedicated to wired communications.

The computing device 900 may include power source/power circuitry 914. The power source/power circuitry 914 may include one or more energy storage devices (e.g., batteries or capacitors) and/or circuitry for coupling components of the computing device 900 to an energy source separate from the computing device 900 (e.g., DC power, AC power, etc.).

The computing device 900 may include a display device 906 (or corresponding interface circuitry, as discussed above). The display device 906 may include any visual indicators, such as a heads-up display, a computer monitor, a projector, a touchscreen display, a liquid crystal display (LCD), a light-emitting diode display, or a flat panel display, for example.

The computing device 900 may include an audio output device 908 (or corresponding interface circuitry, as discussed above). The audio output device 908 may include any device that generates an audible indicator, such as speakers, headsets, or earbuds, for example.

The computing device 900 may include an audio input device 918 (or corresponding interface circuitry, as discussed above). The audio input device 918 may include any device that generates a signal representative of a sound, such as microphones, microphone arrays, or digital instruments (e.g., instruments having a musical instrument digital interface (MIDI) output).

The computing device 900 may include a GPS device 916 (or corresponding interface circuitry, as discussed above). The GPS device 916 may be in communication with a satellite-based system and may receive a location of the computing device 900, as known in the art.

The computing device 900 may include a sensor 930 (or one or more sensors). The computing device 900 may include corresponding interface circuitry, as discussed above). Sensor 930 may sense physical phenomenon and translate the physical phenomenon into electrical signals that can be processed by, e.g., processing device 902. Examples of sensor 930 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

The computing device 900 may include another output device 910 (or corresponding interface circuitry, as discussed above). Examples of the other output device 910 may include an audio codec, a video codec, a printer, a wired or wireless transmitter for providing information to other devices, haptic output device, gas output device, vibrational output device, lighting output device, home automation controller, or an additional storage device.

The computing device 900 may include another input device 920 (or corresponding interface circuitry, as discussed above). Examples of the other input device 920 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 900 may have any desired form factor, such as a handheld or mobile computer system (e.g., a cell phone, a smart phone, a mobile Internet device, a music player, a tablet computer, a laptop computer, a netbook computer, a personal digital assistant (PDA), an ultramobile personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device (e.g., light bulb, cable, power plug, power source, lighting system, audio assistant, audio speaker, smart home device, smart thermostat, camera monitor device, sensor device, smart home doorbell, motion sensor device), a virtual reality system, an augmented reality system, a mixed reality system, or a wearable computer system. In some embodiments, the computing device 900 may be any other electronic device that processes data.

### Select Examples

Example 1 provides a method, including receiving a labeled data entry including a query, an identifier for a content item, and a label corresponding to the query and the content item; translating the labeled data entry into a prompt; inputting the prompt into one or more machine learning models; determining a decision about the labeled data entry based on one or more predictions of the one or more machine learning models in response to the prompt; in response to the decision, generating a test from the labeled data entry; testing a further machine learning model using the test; and updating the further machine learning model based on the labeled data entry, and a prediction made by the further machine learning model in response to the testing.

Example 2 provides the method of example 1, where the prompt includes a title of the content item, the query, and metadata associated with the content item.

Example 3 provides the method of example 1 or 2, where the prompt includes a question whether the content item matches the query.

Example 4 provides the method of any one of examples 1-3, where the prompt includes metadata about the content item.

Example 5 provides the method of any one of examples 1-4, where determining the decision about the labeled data entry includes determining whether the one or more predictions of the one or more machine learning models contrast with the label.

Example 6 provides the method of any one of examples 1-5, where: determining the decision about the labeled data entry includes determining whether the labeled data entry is a false-positive; and generating the test includes generating the test in response to determining false positiveness of the label data entry.

Example 7 provides the method of any one of examples 1-6, where the test includes the query and the content item.

Example 8 provides the method of any one of examples 1-7, where the test includes the prompt.

Example 9 provides the method of any one of examples 1-7, where testing the further machine learning model includes translating, based on the labeled data entry, the query and the content item into a test prompt; and inputting the test prompt to the further machine learning model.

Example 10 provides the method of any one of examples 1-8, where updating the further machine learning model includes comparing the prediction and the label of the labeled data entry.

Example 11 provides the method of any one of examples 1-9, where updating the further machine learning model includes determining that the prediction matches the label of the labeled data entry the labeled data.

Example 12 provides the method of any one of examples 1-10, where updating the further machine learning model includes determining that the labeled data entry is a negative training sample; computing a loss function based on the negative training sample; and updating parameters of the further machine learning model to minimize the loss function.

Example 13 provides one or more non-transitory computer-readable media having instructions stored thereon, when the instructions are executed by one or more processors, causes the one or more processors to: input a prompt to one or more machine learning models, the prompt being generated from a labeled data entry, and the labeled data entry including a query, an identifier for a content item, and a label corresponding to the query and the content item; determine, from one or more outputs generated by one or more machine learning models, that the labeled data entry is a false-positive; in response to determining that the labeled data entry is a false-positive, input a test prompt to a further machine learning model, the test prompt being generated from the labeled data entry; determine that a test prediction generated by the further machine learning model matches the label of the labeled data entry; and train the further machine learning model using the labeled data entry as a negative training sample.

Example 14 provides the one or more non-transitory computer-readable media of example 13, where the prompt includes a question and contextual information about the content item with which the one or more machine learning models are to use to generate an answer to the question.

Example 15 provides the one or more non-transitory computer-readable media of example 13 or 14, where: the one or more machine learning models includes a plurality of different expert models; the one or more outputs generated by the plurality of different expert models includes a plurality of outputs; and determining that the labeled data entry is a false-positive includes combining the plurality of outputs into a combined output; and comparing the combined output against the label.

Example 16 provides a computer-implemented system including one or more data sources for generating training data for training a machine learning model; a checker, including one or more models to generate one or more responses about a query and a content item in a labeled data entry from the one or more data sources; and an evaluate part to evaluate the one or more responses, and output a test in response to determining, based on the one or more responses, that the labeled data entry has a false-positive label; the machine learning model to receive a test prompt generated from the test and generate a test prediction in response to the test prompt; a further evaluate part to determine that the test prediction matches the false-positive label; and an update part to update parameters of the machine learning model based on the labeled data entry being a negative training sample.

Example 17 provides the computer-implemented system of example 16, where the checker further includes a removal part to remove the labeled data entry from the training data.

Example 18 provides the computer-implemented system of example 16 or 17, where the checker further includes a modify part to correct the label in the labeled data entry.

Example 19 provides the computer-implemented system of any one of examples 16-18, where: the checker further includes a translator part to generate a prompt based on the query, the content item, and metadata about the content item; the one or more models includes a large language model; and the large language model receives the prompt and generates the response based on the prompt.

Example 20 provides the computer-implemented system of any one of examples 16-19, where: the one or more models includes a plurality of expert large language models; the one or more responses includes a plurality of responses generated by the expert large language models; and the expert large language models receives a prompt including the query and the content item, and generates the plurality responses based on the prompt.

Example A provides one or more non-transitory computer-readable media storing instructions that, when executed by one or more processors, cause the one or more processors to perform any one of the methods provided in examples 1-12.

Example B provides an apparatus comprising means to carry out or means for carrying out any one of the computer-implemented methods provided in examples 1-12.

Example C provides a computer-implemented system, comprising one or more processors, and one or more non-transitory computer-readable media storing instructions that, when executed by the one or more processors, cause the one or more processors to perform any one of the methods provided in examples 1-12.

### Variations and Other Notes

Although the operations of the example methods shown in and described with reference to FIGS. 1-8 are illustrated as occurring once each and in a particular order, it will be recognized that the operations may be performed in any suitable order and repeated as desired. Additionally, one or more operations may be performed in parallel. Furthermore, the operations illustrated in FIGS. 1-8 may be combined or may include more or fewer details than described.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

1. A method, comprising:
receiving a labeled data entry comprising a query, an identifier for a content item, and a label corresponding to the query and the content item;
translating the labeled data entry into a prompt;
inputting the prompt into one or more machine learning models;
determining a decision about the labeled data entry based on one or more predictions of the one or more machine learning models in response to the prompt;
in response to the decision, generating a test from the labeled data entry;
testing a further machine learning model using the test; and
updating the further machine learning model based on the labeled data entry, and a prediction made by the further machine learning model in response to the testing.

2. The method of claim 1, wherein the prompt includes a title of the content item, the query, and metadata associated with the content item.

3. The method of claim 1, wherein the prompt includes a question whether the content item matches the query.

4. The method of claim 1, wherein the prompt includes metadata about the content item.

5. The method of claim 1, wherein determining the decision about the labeled data entry comprises:
determining whether the one or more predictions of the one or more machine learning models contrast with the label.

6. The method of claim 1, wherein:
determining the decision about the labeled data entry comprises determining whether the labeled data entry is a false-positive; and
generating the test comprises generating the test in response to determining false positiveness of the label data entry.

7. The method of claim 1, wherein the test comprises the query and the content item.

8. The method of claim 1, wherein the test comprises the prompt.

9. The method of claim 1, wherein testing the further machine learning model comprises:
translating, based on the labeled data entry, the query and the content item into a test prompt; and
inputting the test prompt to the further machine learning model.

10. The method of claim 1, wherein updating the further machine learning model comprises:
comparing the prediction and the label of the labeled data entry.

11. The method of claim 1, wherein updating the further machine learning model comprises:
determining that the prediction matches the label of the labeled data entry the labeled data.

12. The method of claim 1, wherein updating the further machine learning model comprises:
determining that the labeled data entry is a negative training sample;
computing a loss function based on the negative training sample; and
updating parameters of the further machine learning model to minimize the loss function.

13. One or more non-transitory computer-readable media having instructions stored thereon, when the instructions are executed by one or more processors, causes the one or more processors to:
input a prompt to one or more machine learning models, the prompt being generated from a labeled data entry, and the labeled data entry comprising a query, an identifier for a content item, and a label corresponding to the query and the content item;
determine, from one or more outputs generated by one or more machine learning models, that the labeled data entry is a false-positive;
in response to determining that the labeled data entry is a false-positive, input a test prompt to a further machine learning model, the test prompt being generated from the labeled data entry;
determine that a test prediction generated by the further machine learning model matches the label of the labeled data entry; and
train the further machine learning model using the labeled data entry as a negative training sample.

14. The one or more non-transitory computer-readable media of claim 13, wherein the prompt comprises a question and contextual information about the content item with which the one or more machine learning models are to use to generate an answer to the question.

15. The one or more non-transitory computer-readable media of claim 13, wherein:
the one or more machine learning models comprises a plurality of different expert models;
the one or more outputs generated by the plurality of different expert models comprises a plurality of outputs; and
determining that the labeled data entry is a false-positive comprises:
combining the plurality of outputs into a combined output; and
comparing the combined output against the label.

16. A computer-implemented system comprising:
one or more data sources for generating training data for training a machine learning model;
a checker, comprising:
one or more models to generate one or more responses about a query and a content item in a labeled data entry from the one or more data sources; and
an evaluate part to evaluate the one or more responses, and output a test in response to determining, based on the one or more responses, that the labeled data entry has a false-positive label;
the machine learning model to receive a test prompt generated from the test and generate a test prediction in response to the test prompt;
a further evaluate part to determine that the test prediction matches the false-positive label; and
an update part to update parameters of the machine learning model based on the labeled data entry being a negative training sample.

17. The computer-implemented system of claim 16, wherein the checker further includes a removal part to remove the labeled data entry from the training data.

18. The computer-implemented system of claim 16, wherein the checker further includes a modify part to correct the label in the labeled data entry.

19. The computer-implemented system of claim 16, wherein:
the checker further includes a translator part to generate a prompt based on the query, the content item, and metadata about the content item;
the one or more models comprises a large language model; and
the large language model receives the prompt and generates the response based on the prompt.

20. The computer-implemented system of claim 16, wherein:
the one or more models comprises a plurality of expert large language models;
the one or more responses comprises a plurality of responses generated by the expert large language models; and
the expert large language models receives a prompt comprising the query and the content item, and generates the plurality responses based on the prompt.
